(19) United States
(12) Patent Application Publication
(10) Pub. No.: US 2025/0178132 A1
(43) Pub. Date: Jun. 5, 2025

(54) ALUMINUM ALLOY BRAZING SHEET

(71) Applicant: UACJ Corporation, Tokyo (JP)

(72) Inventors: Tomoki Yamayoshi, Tokyo (JP); Hidetoshi Kumagai, Tokyo (JP); Shogo Yamada, Kariya-shi (JP); Nobuhiro Homma, Kariya-shi (JP); Taro Fukuda, Kariya-shi (JP); Yosuke Uchida, Kariya-shi (JP)

(73) Assignee: UACJ Corporation, Tokyo (JP)

(21) Appl. No.: 18/846,345

(22) PCT Filed: Feb. 13, 2023
(86) PCT No.: PCT/JP2023/004693

§ 371 Date: Sep. 12, 2024

(30) Foreign Application Priority Data
Mar. 23, 2022 (JP) 2022-047156

(51) Int. Cl. B23K 35/02; B23K 35/28; B23K 103/10; C22C 21/02

(52) U.S. Cl. CPC B23K 35/0238; B23K 35/286; C22C 21/02; B23K 2103/10

(57) ABSTRACT

Provided is an aluminum alloy brazing sheet with cladding material 1/internal brazing material 1/core material, the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % of Bi with the balance being Al and inevitable impurities; the cladding material 1 is formed of an aluminum alloy comprising 6.00 mass % to 13.00 mass % of Si, having a Mg content of 0.050 mass % or less, having a Bi content of 0.050 mass % or less, with the balance being Al and inevitable impurities, and an average Mg concentration in a thickness direction is more than 0.50 mass % and an average Bi concentration in the thickness direction is more than 0.050 mass %.

### TECHNICAL FIELD

The present invention relates to an aluminum alloy brazing sheet used for brazing in an inert gas atmosphere without using a flux.

### BACKGROUND ART

For aluminum heat exchangers and mechanical components, brazing techniques that can simultaneously joint many joint parts are widely used. Aluminum is quickly covered with a dense oxide film because aluminum has highly oxidizable properties. Consequently, while aluminum has excellent corrosion resistance, the joint is difficult to achieve. Therefore, in aluminum brazing, it is important to inhibit the growth of a surface oxide film and to break the film. Two major methods are in practical use, that is, a method for heating in vacuum without using a flux and a method for using a flux in nitrogen gas.

In the method for heating in vacuum without using the flux, a brazing material formed of an Al—Si—Mg-based alloy is used. Brazing can be performed by raising temperature in a vacuum to prevent the growth of an oxide film caused by Al and Mg and breaking the oxide film on the material surface due to the evaporation of Mg during melting of a brazing substance. However, this method has the disadvantage of requiring expensive vacuum heating equipment. In addition, there is a problem of a high maintenance cost for removing attached Mg because the evaporated Mg is attached to the inside of a furnace.

On the other hand, in the method for using the flux in nitrogen gas, a brazing material formed of an Al—Si-based alloy and a flux formed of an Al—K—F-based alloy are used. Even in a nitrogen gas atmosphere, which has a higher oxygen concentration than that in vacuum, the melted flux strongly breaks the oxide film on the brazing material surface while preventing the growth of the oxide film on the brazing material surface and thus brazing can be performed. While this method does not require the expensive vacuum heating equipment, there is a problem of the cost of the flux and the high cost of a flux application process. In addition, there are concerns of health and safety and environmental problems when the flux is scattered into the work environment due to evaporation during application to the heat exchanger or during brazing.

Therefore, there are growing needs for jointing without using the flux in an inert gas atmosphere.

To satisfy these needs, for example, Patent Literature 1 has suggested that brazing of a close contact part can be achieved by comprising Mg and Bi in the brazing material and treating the material with an inorganic acid. Although materials comprising Mg in the brazing material cannot be brazed due to the formation of MgO during a heat treatment process in the material production, the brazing can be performed by removing MgO with treatment using the inorganic acid.

In addition, Patent Literature 2 has suggested that brazing can be performed by regulating the amount of Mg in the brazing material and diffusing Mg comprised in the core material during the brazing. Due to the absence of Mg in the brazing material, it is advantageous in that the formation of MgO during material production and during brazing temperature rise is prevented.

On the other hand, Patent Literature 3 has suggested that cladding of an intermediate layer having a high Mg concentration between the brazing material and the core material allows the supply amount of Mg to the brazing material to be increased without adding Mg to the brazing material, and thus the oxide film to be efficiently broken to some extent.

### CITATION LIST

### Patent Literature

Patent Literature 1: Japanese Patent Publication H8-354934-A
Patent Literature 2: Japanese Patent Publication 2014-037576-A
Patent Literature 3: WO 2016/056306

### SUMMARY OF INVENTION

### Technical Problem

However, in Cited Literature 1, MgO grows even during the brazing temperature rise and thus the material surface is covered with a thick oxide film. Therefore, there arises a problem in that sufficient fillets cannot be formed in practical joints having large clearances.

In Cited Literature 2, the amount of Mg that can be added to the core material is limited due to formability and other restrictions and thus brazing heating at high temperature for a long period of time is required to diffuse Mg in the core material into the oxide film. Therefore, in the case of a practical brazing atmosphere, there arises a problem in that the brazing at high temperature for a long period of time accelerates oxidation of aluminum itself and thus the growth of a thick oxide film occurs, resulting in significant deterioration in brazeability.

In addition, Cited Literature 3 has not solved a problem in that the oxide film break non-uniformly progresses, and has not reached a practical level.

Therefore, an object of the present invention is to provide an aluminum alloy brazing sheet having excellent brazeability in brazing in an inert gas atmosphere without using a flux.

### Solution to Problem

As a result of intensive studies for solving the above problems, the inventors of present invention have found that an aluminum ally brazing sheet in which a cladding material layer (cladding material 1) having contents of Mg and Bi equal to or less than predetermined amounts is provided at the outside of a brazing material (internal brazing material 1) comprising Mg and Bi at predetermined amounts, and an average Mg concentration and an average Bi concentration in a thickness direction of the internal brazing material 1 and the cladding material 1 are set to predetermined ranges has excellent brazeability in brazing in an inert gas atmosphere without using a flux, and thus have accomplished the present invention.

That is, the present invention (1) provides an aluminum alloy brazing sheet comprising:
a core material formed of pure aluminum or an aluminum alloy; and
an internal brazing material 1 and a cladding material 1 cladded on at least one side surface of the core material in order of cladding material 1/internal brazing material 1/core material,
the aluminum alloy brazing sheet being used for brazing in an inert gas atmosphere without using a flux, in which
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities,
the cladding material 1 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities, and
an average Mg concentration in a thickness direction of the internal brazing material 1 and the cladding material 1 is more than 0.50 mass % and an average Bi concentration in the thickness direction of the internal brazing material 1 and the cladding material 1 is more than 0,050 mass %.

In addition, the present invention (2) provides the aluminum alloy brazing sheet according to (1), further comprising
a sacrificial anode material A cladded on the other side surface of the core material in order of cladding material 1/internal brazing material 1/core material/sacrificial anode material A, in which:
the sacrificial anode material A is formed of an aluminum alloy comprising any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and formed with the balance being Al and inevitable impurities.

In addition, the present invention (3) provides the aluminum alloy brazing sheet according to (1), further comprising
an outer surface brazing material cladded on the other side surface of the core material in order of cladding material 1/internal brazing material 1/core material/outer surface brazing material, in which
the outer surface brazing material is formed of an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

In addition, the present invention (4) provides the aluminum alloy brazing sheet according to (2), further comprising
an outer surface brazing material cladded on a surface of the sacrificial anode material A on an opposite side to the core material in order of cladding material 1/internal brazing material 1/core material/sacrificial anode material A/outer surface brazing material, in which
the outer surface brazing material is formed of an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

In addition, the present invention (5) provides the aluminum alloy brazing sheet according to (2), further comprising
an internal brazing material 2 and a cladding material 2 cladded on a surface of a sacrificial anode material A on an opposite side to the core material in order of cladding material 1/internal brazing material 1/core material/sacrificial anode material A/internal brazing material 2/cladding material 2, in which
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0,050 mass % or less, and formed with the balance being Al and inevitable impurities.

In addition, the present invention (6) provides the aluminum alloy brazing sheet according to (1), further comprising
an internal brazing material 2 and a cladding material 2 cladded on the other side surface of the core material in order of cladding material 1/internal brazing material 1/core material/internal brazing material 2/cladding material 2, in which
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

In addition, the present invention (7) provides an aluminum alloy brazing sheet comprising:
a core material formed of pure aluminum or an aluminum alloy; and
a sacrificial anode material B1, an internal brazing material 1, and a cladding material 1 cladded on at least one side surface of the core material in order of cladding material 1/internal brazing material 1/sacrificial anode material B1/core material,
the aluminum alloy brazing sheet being used for brazing in an inert gas atmosphere without using a flux, in which
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % or less of Bi and formed with the balance being Al and inevitable impurities,
the cladding material 1 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities,
the sacrificial anode material B1 comprises any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and is formed with the balance being Al and inevitable impurities, and
an average Mg concentration in a thickness direction of the internal brazing material 1 and the cladding material 1 is more than 0.50 mass % and an average Bi concentration in the thickness direction of the internal brazing material 1 and the cladding material 1 is more than 0.050 mass %.

In addition, the present invention (8) provides the aluminum alloy brazing sheet according to (7), further comprising
a sacrificial anode material B2 cladded on the other side surface of the core material in order of cladding material 1/internal brazing material 1/sacrificial anode material B1/core material/sacrificial anode material B2, in which
the sacrificial anode material B2 is an aluminum alloy comprising any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and formed with the balance being Al and inevitable impurities.

In addition, the present invention (9) further provides the aluminum alloy brazing sheet according to (7), further comprising
an outer surface brazing material cladded on the other side surface of the core material in order of cladding material 1/internal brazing material 1/sacrificial anode material B1/core material/outer surface brazing material, in which
the outer surface brazing material is an aluminum alloy comprising 6.00 mass % 20 to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

In addition, the present invention (10) provides the aluminum alloy brazing sheet according to (8), further comprising
an outer surface brazing material cladded on a surface of the sacrificial anode material 2 on an opposite side to the core material in order of cladding material 1/internal brazing material 1/sacrificial anode material B1/core material/sacrificial anode material B2/outer surface brazing material, in which
the outer surface brazing material is an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

In addition, the present invention (11) provides the aluminum alloy brazing sheet according to (8), further comprising
an internal brazing material 2 and a cladding material 2 cladded on a surface of the sacrificial anode material 2 on an opposite side to the core material in order of cladding material 1/internal brazing material 1/sacrificial anode material B1/core material/sacrificial anode material B2/internal brazing material 2/cladding material 2, in which
the internal brazing material 2 is formed of an aluminum alloy comprising 6.00 mass % to 13.00 mass % of Si, more than 0.50 mass % and 4.50 mass % or less of Mg, and 0,010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0,050 mass % or less, and formed with the balance being Al and inevitable impurities.

In addition, the present invention (12) provides the aluminum alloy brazing sheet according to (7), further comprising
an internal brazing material 2 and a cladding material 2 cladded on the other side surface of the core material in order of cladding material 1/internal brazing material 1/sacrificial anode material B1/core material/internal brazing material 2/cladding material 2, in which
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

In addition, the present invention (13) provides the aluminum alloy brazing sheet according to any one of (1) to (12), in which the core material is formed of an aluminum alloy comprising any one or more of 1.50 mass % or less of Si, 1.50 mass % or less of Fe, 2.00 mass % or less of Cu, 2.00 mass % or less of Mn, 3.00 mass % or less of Mg, 3.00 mass % or less of Zn, 0.50 mass % or less of Bi, 0.30 mass % or less of Ct, 0.30 mass % or less of Ti, and 0.30 mass % or less of Zr, and formed with the balance being Al and inevitable impurities.

In addition, the present invention (14) provides the aluminum alloy brazing sheet according to any one of (1) to (13), in which the internal brazing material 1 or the internal brazing material 2 further comprises any one or more of 1.00 mass % or less of Fe, 2.00 mass % or less of Cu, 2.00 mass % or less of Mn, 6.00 mass % or less of Zn, 0.30 mass % or less of Cr, 0.30 mass % or less of Ti, and 0.30 mass % or less of Zr.

In addition, the present invention (15) provides the aluminum alloy brazing sheet according to any one of claims (1) to (14), in which the cladding material 1 or the cladding material 2 further comprises any one or more of 1.00 mass % or less of Fe, 2.00 mass % or less of Cu, 2.00 mass % or less of Mn, 6.00 mass % or less of Zn, 0.30 mass % or less of Cr, 0.30 mass % or less of Ti, and 0.30 mass % or less of Zr.

In addition, the present invention (16) provides the aluminum alloy brazing sheet according to any one of (1) to (15), in which a thickness of the cladding material 1 or the cladding material 2 is 5.0 μm or more.

In addition, the present invention (17) provides the aluminum alloy brazing sheet according to any one of (1) to (16), in which a thickness of the internal brazing material 1 or the internal brazing material 2 is 15.0 μm or more.

### Advantageous Effect of Invention

According to the present invention, an aluminum alloy brazing sheet having excellent brazeability in brazing in an inert gas atmosphere without using a flux can be provided.

### BRIEF DESCRIPTION OF DRAWINGS

FIG. 1 is a view illustrating a test body of an overlapped opening-mouth test.

FIG. 2 is a schematic view of an X-ray CT image obtained by X-ray CT of a fillet shape.

### DESCRIPTION OF EMBODIMENTS

An aluminum alloy brazing sheet of a first embodiment of the present invention is an aluminum alloy brazing sheet comprising:
a core material formed of pure aluminum or an aluminum alloy; and
an internal brazing material 1 and a cladding material 1 cladded on at least one side surface of the core material in order of cladding material 1/internal brazing material 1/core material,
the aluminum alloy brazing sheet being used for brazing in an inert gas atmosphere without using a flux, in which
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities,
the cladding material 1 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities, and
an average Mg concentration in a thickness direction of the internal brazing material 1 and the cladding material 1 is more than 0.50 mass % and an average Bi concentration in a thickness direction of the internal brazing material 1 and the cladding material 1 is more than 0.050 mass %.

An aluminum alloy brazing sheet of a second embodiment of the present invention is an aluminum alloy brazing sheet comprising:
a core material formed of pure aluminum or an aluminum alloy; and
a sacrificial anode material B1, an internal brazing material 1, and a cladding material 1 cladded on at least one side surface of the core material in order of cladding material 1/internal brazing material 1/sacrificial anode material B1/core material,
the aluminum alloy brazing sheet being used for brazing in an inert gas atmosphere without using a flux, in which
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % or less of Bi, and formed with the balance being Al and inevitable impurities,
the cladding material 1 is formed of an aluminum alloy comprising 6.00 mass % to 13.00 mass % of Si, having a Mg content of more than 0.050 mass % or less, having a Bi content of 0.050 mass % or less, and formed with the balance being Al and inevitable impurities,
the sacrificial anode material B1 comprises any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and is formed with the balance being Al and inevitable impurities, and
an average Mg concentration in a thickness direction of the internal brazing material 1 and the cladding material 1 is more than 0.50 mass % and an average Bi concentration in a thickness direction of the internal brazing material 1 and the cladding material 1 is more than 0.050 mass %.

In the production of aluminum alloy heat exchangers, the aluminum alloy brazing sheet of first embodiment of the present invention and the aluminum alloy brazing sheet of second embodiment of the present invention are brazing sheets brazed by forming into the shape of constituent members of the heat exchangers and brazing heating in an inert gas atmosphere without using a flux, that is, aluminum alloy brazing sheets for producing the aluminum alloy heat exchangers and aluminum alloy brazing sheets used in the production of the aluminum alloy heat exchangers by brazing in the inert gas atmosphere without using the flux.

The aluminum alloy brazing sheet of the first embodiment of the present invention comprises the internal brazing material 1 and the cladding material 1 cladded on at least one side surface of the core material in order of cladding material 1/internal brazing material 1/core material. In other words, the aluminum alloy brazing sheet of the first embodiment of the present invention comprises at least the cladding material 1 serving as an outermost layer on one side surface of the core material and the internal brazing material 1 placed just under the cladding material 1. In the aluminum alloy brazing sheet of the first embodiment of the present invention, no materials may be cladded or one or more materials for clad may be cladded on the other side surface of the core material, that is, the surface opposite to the side where the internal brazing material 1 and the cladding material 1 are cladded. Examples of the form of the aluminum alloy brazing sheet of the first embodiment of the present invention include a three-layer material cladded by laminating in order of cladding material 1/internal brazing material 1/core material, a four-layer material cladded by laminating in order of cladding material 1/internal brazing material 1/core material/sacrificial anode material A, a four-layer material cladded by laminating in order of cladding material 1/internal brazing material 1/core material/outer surface brazing material, a five-layer material cladded by laminating in order of cladding material 1/internal brazing material 1/core material/sacrificial anode material A/outer surface brazing material, a five-layer material cladded by laminating in order of cladding material 1/internal brazing material 1/core material/internal brazing material 2/cladding material 2, and a six-layer material cladded by laminating in order of cladding material 1/internal brazing material 1/core material/sacrificial anode material A/internal brazing material 2/cladding material 2. In the case where the aluminum alloy brazing sheet of the first embodiment of the present invention comprises the internal brazing material 2 and the cladding material 2 in addition to the internal brazing material 1 and the cladding material 1, the internal brazing material 1 and the internal brazing material 2 may have the same chemical composition or different chemical compositions, and the cladding material 1 and the cladding material 2 may have the same chemical composition or different chemical compositions.

The aluminum alloy brazing sheet of the second embodiment of the present invention comprises the sacrificial anode material B1, the internal brazing material 1, and the cladding material 1 cladded by laminating in order of cladding material 1/internal brazing material 1/sacrificial anode material B1/core material on at least one side surface of the core material. In other words, the aluminum alloy brazing sheet of the second embodiment of the present invention comprises the cladding material 1 serving as the outermost layer, the internal brazing material 1 placed just under the cladding material 1, and the sacrificial anode material B1 placed just under the internal brazing material 1 on one side surface of the core material. In the aluminum alloy brazing sheet of the second embodiment of the present invention, no materials may be cladded or one or more materials for clad may be cladded on the other side surface of the core material, that is, the surface opposite to the side where the sacrificial anode material B1, the internal brazing material 1, and the cladding material 1 are cladded. Examples of the form of the aluminum alloy brazing sheet of the second embodiment of the present invention include a four-layer material cladded by laminating in order of cladding material 1/internal brazing material 1/sacrificial anode material B1/core material, a five-layer material cladded by laminating in order of cladding material 1/internal brazing material 1/sacrificial anode material B1/core material/sacrificial anode material B2, a five-layer material cladded by laminating in order of cladding material 1/internal brazing material 1/sacrificial anode material B1/core material/outer surface brazing material, a six-layer material cladded by laminating in order of cladding material 1/internal brazing material 1/sacrificial anode material B1/core material/sacrificial anode material B2/outer surface brazing material, a six-layer material cladded by laminating in order of cladding material 1/internal brazing material 1/sacrificial anode material B1/core material/internal brazing material 2/cladding material 2, and a seven-layer material cladded by laminating in order of cladding material brazing material 1/sacrificial anode material B1/core material/sacrificial anode material B2/internal brazing material 2/cladding material 2. In the case where the aluminum alloy brazing sheet of the second embodiment of the present invention comprises the sacrificial anode material B2 in addition to the sacrificial anode material B1, the sacrificial anode material B1 and the sacrificial anode material B2 may have the same chemical composition or different chemical compositions. In the case where the aluminum alloy brazing sheet of the second embodiment of the present invention comprises the internal brazing material 2 and the cladding material 2 in addition to the internal brazing material 1 and the cladding material 1, the internal brazing material 1 and the internal brazing material 2 may have the same chemical composition or different chemical compositions, and the cladding material 1 and the cladding material 2 may have the same chemical composition or different chemical compositions.

The core material according to the aluminum alloy brazing sheet of the first embodiment of the present invention and the core material according to the aluminum alloy brazing sheet of the second embodiment of the present invention are similar. The cladding material 1 and the cladding material 2 according to the aluminum alloy brazing sheet of the first embodiment of the present invention and the cladding material 1 and the cladding material 2 according to the aluminum alloy brazing sheet of the second embodiment of the present invention are similar. The internal brazing material 1 according to the aluminum alloy brazing sheet of the first embodiment of the present invention and the internal brazing material 1 according to the aluminum alloy brazing sheet of the second embodiment of the present invention are similar. The sacrificial anode material A according to the aluminum alloy brazing sheet of the first embodiment of the present invention and the sacrificial anode material B1 and the sacrificial anode material B2 according to the aluminum alloy brazing sheet of the second embodiment of the present invention are similar. The outer surface brazing material according to the aluminum alloy brazing sheet of the first embodiment of the present invention and the outer surface brazing material according to the aluminum alloy brazing sheet of the second embodiment of the present invention are similar. The internal brazing material 2 according to the aluminum alloy brazing sheet of the first embodiment of the present invention and the internal brazing material 2 according to the aluminum alloy brazing sheet of the second embodiment of the present invention are similar.

The core materials according to the aluminum alloy brazing sheet of the first embodiment of the present invention and the aluminum alloy brazing sheet of the second embodiment of the present invention are formed of pure aluminum or an aluminum alloy.

In the case where the core material is formed of pure aluminum, the purity of the pure aluminum is not particularly limited and is preferably 99.0 mass % or more and particularly preferably 99.5 mass % or more. Examples of the pure aluminum materials include A1100, A1050, and A1080.

In the case where the core material is formed of the aluminum alloy, the composition of the aluminum alloy forming the core material is not particularly limited as long as the aluminum alloy can be used as the core material of the aluminum alloy brazing sheet for producing the aluminum alloy heat exchangers. As the core material, a core material formed of an aluminum alloy comprising any one or more of 1.50 mass % or less of Si, 1.50 mass % or less of Fe, 2.00 mass % or less of Cu, 2.00 mass % or less of Mn, 3.00 mass % or less of Zn, 0.30 mass % or less of Cr, 0.30 mass % or less of Ti, and 0.30 mass % or less of Zr, and formed with the balance being Al and inevitable impurities is preferable.

In the core material of the aluminum alloy, Si contributes to strength enhancement. In the case where the core material comprises Si, the Si content in the core material is 1.50 mass % or less and preferably 0.10 mass % to 1.00 mass %. The Si content in the core material within the above range allows the strength of the core material to be improved. On the other hand, a Si content in the core material of more than the above range causes the melting point to become excessively low, local melting to occur during brazing, and deformation of the core material to occur, resulting in lower corrosion resistance.

Fe contributes to strength enhancement. In the case where the core material comprises Fe, the Fe content in the core material is 1.50 mass % or less and preferably 0.10 mass % to 0.70 mass %. The Fe content in the core material within the above range allows the strength of the core material to be improved. On the other hand, a Fe content in the core material of more than the above range causes corrosion resistance to deteriorate and giant compounds to be easily generated.

Cu contributes to strength enhancement and potential adjustment. In the case where the core material comprises Cu, the Cu content in the core material is 2.00 mass % or less and preferably 0.10 mass % to 1.00 mass %. The Cu content in the core material within the above range allows the strength of the core material to be improved. On the other hand, a Cu content in the core material of more than the above range causes intergranular corrosion to easily occur and the melting point to be excessively low.

Mn contributes to strength enhancement and potential adjustment. In the case where the core material comprises Mn, the Mn content in the core material is 2.00 mass % or less and preferably 0.30 mass % to 1.80 mass %. The Mn content in the core material within the above range allows the strength of the core material to be improved and a potential adjustment effect to be achieved. On the other hand, a Mn content in the core material of more than the above range causes cracks to be easily generated during material rolling.

Zn contributes to potential adjustment. In the case where the core material comprises Zn, the Zn content in the core material is 3.00 mass % or less and preferably 0.50 mass % to 3.00 mass %. The Zn content in the core material within the above range allows the potential adjustment effect to be achieved. On the other hand, a Zn content in the core material of more than the above range causes natural electrode potential to be excessively low, resulting in lower corrosion resistance.

Cr improves strength by solid solution strengthening, also precipitates fine Al—Cr-based compounds, and acts on coarsening grains after brazing. The Cr content in the core material is 0.30 mass % or less and preferably 0.10 mass % to 0.20 mass %. The Cr content in the core material within the above range allows the strength of the core material to be improved. On the other hand, a Cr contents in the core material of more than the above range causes giant intermetallic compounds to be easily formed during casting and thus plastic workability to deteriorate.

Ti improves strength by solid solution strengthening, and is distributed in layers to form high and low potential layers in the core material, whereby the corrosion form changes from pitting corrosion to layer corrosion to exhibit the effect of improving corrosion resistance. The Ti content in the core material is 0.30 mass % or less and preferably 0.10 mass % to 0.20 mass %. The Ti content in the core material within the above range allows the strength of the core material to be improved and corrosion resistance to be improved. On the other hand, a Ti content in the core material of more than the above range may cause giant intermetallic compound to be easily formed during casting and thus plastic workability to deteriorate.

Zr improves strength by solid solution strengthening, also precipitates Al—Zr-based fine compounds, and acts on coarsening grains after brazing. The Zr content in the core material is 0.30 mass % or less and preferably 0.10 mass % to 0.20 mass %. The Zr content in the core material within the above range allows the strength of the core material to be improved and the effect of coarsening grains after brazing to be achieved. On the other hand, a Zr content in the core material of more than the above range causes giant intermetallic compounds to be easily formed during casting and thus plastic workability to deteriorate.

The core material may comprise Mg. In the core material of the aluminum alloy, Mg diffuses into the internal brazing material 1 or the cladding material 1 during brazing heating, promotes the breaking of the oxide film on the material surface, and contributes to improving brazeability. In the case where the core material comprises Mg, the Mg content in the core material is 3.00 mass % or less and preferably 0.30 mass % to 1.80 mass %. The Mg content in the core material within the above range: allows the effect of brazeability improvement to be easily achieved. On the other hand, a Mg content in the core material of more than the above range causes cracks to be easily generated during material rolling.

The core material may comprise Bi. In aluminum alloys forming the core material, in the case where Bi causes a part of the core material to melt by melting the internal brazing material 1 or the cladding material 1 during brazing heating, Bi acts to reduce the decrease in the Bi concentration in the internal brazing material 1 or the cladding material 1 and exhibits the promoting action for breaking of the oxide film due to Mg. In the case where the core martial comprises Bi, the Bi content in the core material is 0.50 mass % or less and preferably 0.10 mass % to 0.40 mass %. The Bi content in the core material within the above range allows the action of promoting the breaking of the oxide film due to Mg to be achieved. On the other hand, a Bi content of more than the above range causes cracks to be easily generated during material production and thus production of the brazing sheet to be difficult.

The core material may comprise 0.050 mass % or less of Ag, B. Be, Ca, Cd, Co, Ga, Ge, Hg, In, Li, Mo, Na, Ni, P, Pb, Sb, Sn, Sr, V, and Y as unavoidable impurities.

The internal brazing material 1 and the internal brazing material 2 according to the aluminum alloy brazing sheet of the first embodiment of the present invention and the aluminum alloy brazing sheet of the second embodiment of the present invention are formed of an aluminum alloy comprising 6.00 mass % to 13.00 mass % Si, more than 0.50 mass % and 4.50 mass % or less of Mg, and 0,010 mass % to 0.50 mass % of Bi, and formed with the balance being Al and inevitable impurities.

The internal brazing material 1 and the internal brazing material 2 comprise Si. In the aluminum alloy brazing material, Si contributes to brazing jointability. The Si contents in the internal brazing material 1 and the internal brazing material 2 are 6.00 mass % to 13.00 mass %. The Si contents in the internal brazing material 1 and the internal brazing material 2 within the above range allow the sufficient brazing jointability to be obtained. Si contents in the internal brazing material 1 and the internal brazing material 2 of less than the above range cause jointability to be inferior, whereas Si contents of more than the above range cause cracks to be easily generated during material production and thus the production of the brazing sheet to be difficult.

The internal brazing material 1 and the internal brazing material 2 comprise Mg. The Mg contents in the internal brazing material 1 and the internal brazing material 2 are more than 0.50 mass % and 4.50 mass % or less and preferably 0.60 mass % to 4.00 mass %. The Mg contents in the internal brazing material 1 and the internal brazing material 2 within the above range allow the sufficient brazing jointability to be obtained. Mg contents in the internal brazing material 1 and the internal brazing material 2 of the above range or less cause breaking effect of the oxide film to be inferior, whereas Mg contents of more than the above range cause cracks to be easily generated during material production and thus the production of the brazing sheet to be difficult.

The internal brazing material 1 and the internal brazing material 2 comprise Bi. The Bi contents in the brazing material 1 and the internal brazing material 2 are 0,010 mass % to 0.50 mass % and preferably 0.020 mass % to 0.45 mass %. The Bi contents in the internal brazing material 1 and the internal brazing material 2 within the above range allow the sufficient brazing jointability to be obtained. Bi contents in the internal brazing material 1 and the internal brazing material 2 of less than the above range cause action of promoting the breaking effect of the oxide film due to Mg to be insufficient, whereas Bi contents of more than the above range cause cracks to be easily generated during material production and thus the production of the brazing sheet to be difficult.

The internal brazing material 1 and the internal brazing material 2 may comprise any one or more of Na, Sr, and Sb. In the aluminum alloy forming the brazing material, Na, Sr, and Sb exhibit the effect of forming fine Si particles in the brazing material and improving the fluidity of the brazing substance. In the case where the internal brazing material 1 and the internal brazing material 2 comprise Na, the Na contents are 0.050 mass % or less and preferably 0.005 mass % to 0.040 mass %. In the case where the internal brazing material 1 and the internal brazing material 2 comprise Sr, the Sr contents are 0.050 mass % or less, preferably 0.005 mass % to 0.040 mass %. In the case where the internal brazing material 1 and the internal brazing material 2 comprise Sb, the Sb contents are 0.050 mass % or less, preferably 0.005 mass % to 0.040 mass %. The contents of Na, Sr, and Sb in the internal brazing material 1 and the internal brazing material 2 within the above ranges allow the effect of forming fine Si particles to be achieved. On the other hand, contents of Na, Sr, and Sb in the internal brazing material 1 and the internal brazing material 2 of more than the above ranges cause the effect to be saturated, which is not economical.

The internal brazing material 1 and the internal brazing material 2 may comprise any one or two of Zn and Cu. In the aluminum alloy forming the internal brazing material 1 and the internal brazing material 2, Zn and Cu lower the melting point of the brazing material 1 and the internal brazing material 2 and enable brazing at a temperature of lower than 600° C., which is a common brazing temperature.

In the case where the internal brazing material 1 and the internal brazing material 2 comprise Zn, the Zn contents are preferably 6.00 mass % or less, particularly preferably 1.00 mass % to 5.50 mass %, and further preferably 3.00 mass % to 5.00 mass % form the viewpoint of easily achieving the effect of lowering the melting point of the brazing material. On the other hand, Zn contents in the internal brazing material 1 and the internal brazing material 2 of more than the above range cause cracks to be generated during material production and thus the production of the brazing sheet to be difficult. In the case where the internal brazing material 1 and the internal brazing material 2 comprise Zn, the Zn contents in the internal brazing material 1 and the internal brazing material 2 are preferably 3.00 mass % or less from the viewpoint that the effect of preventing corrosion of the core material is easily achieved by setting the potential of the brazing materials less-noble and preferentially corroding the brazing materials against the core material.

In the case where the internal brazing material 1 and the internal brazing material 2 comprise Cu, the Cu contents are 2.00 mass % or less, preferably 0.50 mass % to 2.00 mass %, and particularly preferably 1.00 mass % to 2.00 mass %. The Cu contents in the internal brazing material 1 and the internal brazing material 2 within the above range allow the effect of lowering the melting point of the brazing material to be improved. On the other hand, Cu contents in the internal brazing material 1 and the internal brazing material 2 of more than the above range cause cracks to be generated during material production, and thus the production of the brazing sheet to be difficult.

The internal brazing material 1 and the internal brazing material 2 may comprise Fe. In the aluminum alloy forming the brazing material, Fe precipitates relatively coarse Al—Fe-based compounds and acts to form fine grains of the remaining brazing material after brazing. In the case where the internal brazing material 1 and the internal brazing material 2 comprise Fe, the Fe contents are 1.00 mass % or less and preferably 0.10 mass % to 0.50 mass %. The Fe contents in the internal brazing material 1 and the internal brazing material 2 within the above range allow the effect of forming fine grains to be easily achieved. On the other hand, Fe contents in the internal brazing material 1 and the internal brazing material 2 of more than the above range cause giant intermetallic compounds to be easily formed during casting and thus plastic workability to deteriorate.

The internal brazing material 1 and the internal brazing material 2 may comprise any one or more of Mn, Cr, Ti, and Zr. In the aluminum alloy forming the brazing material, Mn, Cr, Ti, and Zr precipitate Al—Mn-based, Al—Cr-based, Al—Ti-based, and Al—Zr-based fine compounds, respectively and act on coarsening grains of the remaining brazing material after brazing.

In the case where the internal brazing material 1 and the internal brazing material 2 comprise Mn, the Mn contents are 2.00 mass % or less and preferably 0.10 mass % to 0.60 mass %. The Mn contents in the internal brazing material 1 and the internal brazing material 2 within the above range allow the effect of coarsening grains to be easily achieved. On the other hand, Mn contents in the internal brazing material 1 and the internal brazing material 2 of more than the above range cause giant intermetallic compounds to be easily formed during casting and thus plastic workability to deteriorate.

In the case where the internal brazing material 1 and the internal brazing material 2 comprise Cr, the Cr contents are 0.30 mass % or less and preferably 0.10 mass % to 0.20 mass %. The Cr contents in the internal brazing material 1 and the internal brazing material 2 within the above range allow the effect of coarsening grains to be easily achieved. On the other hand, Cr contents in the internal brazing material 1 and the internal brazing material 2 of more than the above range cause giant: intermetallic compounds to be easily formed during casting and thus plastic workability to deteriorate.

When the internal brazing material 1 and the internal brazing material 2 comprise Ti, the Ti contents are 0.30 mass % or less and preferably 0.10 mass % to 0.20 mass %. The Ti contents in the internal brazing material 1 and internal brazing material 2 within the above range allow the effect of coarsening grains to be easily achieved. On the other hand, Ti contents in the internal brazing material 1 and the internal brazing material 2 of more than the above range cause giant intermetallic compounds to be easily formed during casting and thus plastic workability to deteriorate.

In the case where the internal brazing material 1 and the internal brazing material 2 comprise Zr, the Zr contents are 0.30 mass % or less and preferably 0.10 mass % to 0.20 mass %. The Zr contents in the internal brazing material 1 and the internal brazing material 2 within the above range allow the effect of coarsening grains to be easily achieved. On the other hand, Zr contents in the internal brazing material 1 and the internal brazing material 2 of more than the above range cause giant intermetallic compounds to be easily formed during casting and thus plastic workability to deteriorate.

The grain size after brazing is adjusted by utilizing the above actions. The effects of the present invention can be sufficiently achieved when the contents are within the above ranges.

The internal brazing material 1 and the internal brazing material 2 may comprise 0.050 mass % or less of Ag, B, Be, Ca, Cd, Co, Ga, Ge, Hg, In, Li, Mo, Ni, P, Pb, Sn, V, and Y as unavoidable impurities.

The cladding material 1 and the cladding material 2 according to the aluminum alloy brazing sheet of the first embodiment of the present invention and the aluminum alloy brazing sheet of the second embodiment of the present invention are formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

The cladding material 1 and the cladding material 2 comprise Si. Si comprised in the cladding material 1 and the cladding material 2 contributes to brazing jointability by reducing decrease in the Si contents of the cladding material 1 and the cladding material 2 when the cladding material 1 and the cladding material 2 are fused with the internal brazing material 1 and the internal brazing material 2, respectively, at the brazing temperature. The Si contents in the cladding material 1 and the cladding material 2 are 6.00 mass % to 13.00 mass %. The Si contents in the cladding material 1 and the cladding material 2 within the above range allow sufficient brazing jointability to be obtained. On the other hand, Si contents in the cladding material 1 and the cladding material 2 of less than the above range cause the Si contents in the internal brazing material 1 and the internal brazing material 2 to be lowered and thus brazeability to deteriorate. Si contents of more than the above range cause cracks to be easily generated during material production and thus production of the brazing sheet to be difficult.

The cladding material 1 and the cladding material 2 preferably comprise no Mg or have Mg contents as low as possible. In the aluminum alloy forming the cladding material 1 and the cladding material 2, Mg assists the growth of the oxide film during brazing heating and thus deteriorate brazeability. Therefore, the Mg contents in the cladding material 1 and the cladding material 2 are regulated to 0.050 mass % or less, which is an unavoidable impurity level. The Mg contents in the cladding material 1 and the cladding material 2 within the above range allow the brazeability not to deteriorate. On the other hand, Mg contents in the cladding material 1 and the cladding material 2 of more than the above range cause, before brazing substance melting during brazing heating, Mg to break the oxide film on the surface of the material that does not need to be broken yet, resulting in growing a thick oxide film until the brazing substance melts. In addition, this thick oxide film comprises Mg and thus the oxide film is difficult to reduce and break by the same Mg, resulting in deterioration in brazeability.

The cladding material 1 and the cladding material 2 may comprise Bi. The Bi content in the cladding material 1 is set to satisfy the average Bi concentration in the thickness direction of the internal brazing material 1 and the cladding material 1 as described later. The Bi content in the cladding material 1 is regulated to, for example, 0.050 mass % or less, which is an unavoidable impurity level. The Bi content in the cladding material 2 is preferably set to satisfy the average Bi concentration in the thickness direction of the internal brazing material 2 and the cladding material 2 as described later.

The cladding material 1 and the cladding material 2 may comprise any one or more of Na, Sr, and Sb. In the aluminum alloy forming the cladding material 1 and the cladding material 2, Na, Sr, and Sb exhibit the effect of forming fine Si particles in the cladding material 1 and the cladding material 2 and improving the fluidity of the brazing substance, In the case where the cladding material 1 and the cladding material 2 comprise Na, the Na contents are 0.050 mass % or less and preferably 0.005 mass % to 0.040 mass %. In the case where the cladding material 1 and the cladding material 2 comprise Sr, the Sr contents are 0.050 mass % or less and preferably 0.005 mass % to 0.040 mass %. In the case where the cladding material 1 and the cladding material 2 comprise Sb, the Sb contents are 0.050 mass % or less and preferably 0.005 mass % to 0.040 mass %. The contents of Na, Sr, and Sb in the cladding material 1 and the cladding material 2 within the above ranges allow the effect of forming fine Si particles to be achieved. On the other hand, contents of Na, Sr, and Sb in the cladding material 1 and the cladding material 2 of more than the above ranges cause the effect to be saturated, which is not economical.

The cladding material 1 and the cladding material 2 may comprise any one or two of Zn and Cu. In the aluminum alloy forming the cladding material 1 and the cladding material 2, Zn and Cu allow the melting points of the cladding material 1 and the cladding material 2 to be lowered and the cladding material 1 and the cladding material 2 to fuse with the internal brazing material 1 and the internal brazing material 2, respectively, at a temperature of lower than 600° C., which is a common brazing temperature.

In the case where the cladding material 1 and the cladding material 2 comprise Zn, the Zn contents are preferably 6.00 mass % or less, particularly preferably 1.00 mass % to 5.50 mass %, and further preferably 3.00 mass % to 5.00 mass % from the viewpoint of easily achieving the effect of lowering the melting points of the cladding material 1 and the cladding material 2. On the other hand, Zn contents in the cladding material 1 and the cladding material 2 of more than the above range cause cracks to be generated during material production and thus production of the brazing sheet to be difficult. In the case where the cladding material 1 and the cladding material 2 comprise Zn, the Zn contents in the cladding material 1 and the cladding material 2 are preferably 3.00 mass % or less from the viewpoint that the effect of preventing corrosion of the core material is easily achieved by setting the potential of the cladding material 1 and the cladding material 2 less-noble and preferentially corroding the cladding materials against the core material.

In the case where the cladding material 1 and the cladding material 2 comprise Cu, the Cu contents are 2.00 mass % or less, preferably 0.50 mass % to 2.00 mass %, and particularly preferably 1.00 mass % to 2.00 mass %. The Cu contents in the cladding material 1 and the cladding material 2 within the above range allow the effect of lowering the melting points of the cladding material 1 and the cladding material 2 to be improved. On the other hand, Cu contents in the cladding material 1 and the cladding material 2 of more than the above range cause cracks to be generated during material production and thus production of the brazing sheet to be difficult.

The cladding material 1 and the cladding material 2 may comprise Fe. In the aluminum alloy forming the cladding material 1 and the cladding material 2, Fe precipitates relatively coarse Al—Fe-based compounds, is fused with the brazing material during brazing, and acts on forming fine grains of the remaining brazing material after brazing. In the case where the cladding material 1 and the cladding material 2 comprise Fe, the Fe contents are 1.00 mass % or less and preferably 0.10 mass % to 0.50 mass %. The Fe contents in the cladding material 1 and the cladding material 2 within the above range allow the effect of forming fine grains to be easily achieved. On the other hand, Fe contents in the cladding material 1 and the cladding material 2 of more than the above range cause giant intermetallic compounds to be easily formed during casting and thus plastic workability to deteriorate.

The cladding material 1 and the cladding material 2 may comprise any one or more of Mn, Cr, Ti, and Zr. In the aluminum alloy forming the cladding material 1 and the cladding material 2, Mn, Cr, Ti, and Zr precipitate Al—Mn-based, Al—Cr-based, Al—Ti-based, and Al—Zr-based fine compounds, respectively, and act on coarsening grains of the remaining brazing material after brazing.

In the case where the cladding material 1 and the cladding material 2 comprise Mn, the Mn contents are 2.00 mass % or less and preferably 0.10 mass % to 0.60 mass %. The Mn contents in the cladding material 1 and the cladding material 2 within the above range allow the effect of coarsening grains to be easily achieved. On the other hand, Mn contents in the cladding material 1 and the cladding material 2 of more than the above range cause giant intermetallic compounds to be easily formed during casting and thus plastic workability to easily deteriorate.

In the case where the cladding material 1 and the cladding material 2 comprise Cr, the Cr contents are 0.30 mass % or less and preferably 0.10 mass % to 0.20 mass % The Cr contents in the cladding material 1 and the cladding material 2 within the above range allow the effect of coarsening grains to be easily achieved. On the other hand, Cr contents in the cladding material 1 and the cladding material 2 of more than the above range cause giant intermetallic compounds to be easily formed during casting and thus plastic workability to deteriorate.

In the case where the cladding material 1 and the cladding material 2 comprise Ti, the Ti contents are 0.30 mass % or less and preferably 0.10 mass % to 0.20 mass % The Ti contents in the cladding material 1 and the cladding material 2 within the above range allow the effect of coarsening grains to be easily achieved. On the other hand, Ti contents in the cladding material 1 and the cladding material 2 of more than the above range cause giant intermetallic compounds to be easily formed during casting and thus plastic workability to deteriorate.

In the case where the cladding material 1 and the cladding material 2 comprise Zr, the Zr contents are 0.30 mass % or less and preferably 0.10 mass % to 0.20 mass %. The Zr contents in the cladding material 1 and the cladding material 2 within the above range allow the effect of coarsening grains to be easily achieved. On the other hand, Zr contents in the cladding material 1 and the cladding material 2 of more than the above range cause giant intermetallic compounds to be easily formed during casting and thus plastic workability to deteriorate.

The grain size after brazing is adjusted by utilizing the above actions. The effects of the present invention can be sufficiently achieved when the contents are within the above ranges.

The cladding material 1 and the cladding material 2 may comprise 0.050 mass % or less of Ag, B, Be, Ca, Cd, Co, Ga, Ge, Hg, In, Li, Mo, Ni, P, Pb, Sn, V, and Y as unavoidable impurities.

In addition, in the aluminum alloy brazing sheet of the first embodiment of the present invention and the aluminum alloy brazing sheet of the second embodiment of the present invention, the average Mg concentration in a thickness direction of the internal brazing material 1 and the cladding material 1 is more than 0.50 mass %, and the average Bi concentration in a thickness direction of the internal brazing material 1 and the cladding material 1 is more than 0.050 mass %.

Mg added to the brazing material layer has smaller free energy of oxide generation than that of aluminum, and thus can reduce and break the surface oxide film in which aluminum is a main composition during brazing heating. However, in a two-layer aluminum alloy brazing sheet formed of the brazing material and the core material, the material in which Mg is added to the brazing material cannot be brazed because MgO is formed during a heat treatment process during material production, and thus this MgO is required to be removed by pretreatment or other treatment. In addition, even before brazing substance melting during brazing heating, Mg in the brazing material breaks the oxide film on the surface of the material that does not need to be broken yet, resulting in growing a thick and strong oxide film until the brazing substance melts. Furthermore, this oxide film comprises Mg, and thus reducing and breaking the oxide film by the same Mg are difficult to occur, resulting in not obtaining sufficient brazeability.

In addition, in a two-layer aluminum alloy brazing sheet formed of the brazing material and the core material, the material in which Mg is added to the core material is advantageous in that MgO formation can be prevented during material production and brazing temperature rise because Mg does not exist in the brazing material. However, there is a limitation to the amount of Mg that can be added to the core material due to formability and other restrictions, and thus brazing heating for a long period of time at high temperatures is required to diffuse Mg in the core material into the oxide film. In the case of practical brazing atmospheres, brazing at high temperatures for long periods of time accelerates oxidation of aluminum itself and thus the oxide film grows thicker, resulting in significant deterioration in brazeability.

Cladding an intermediate layer having a high Mg concentration between the brazing material and the core material allows Mg to be supplied from the intermediate layer without adding Mg to the brazing material and the oxide film to be efficiently broken to some extent. This material has high brazeability even in brazing heating for a relatively short period of time. In the case of practical brazing atmospheres, however, aluminum itself oxidizes to grow a thick and strong oxide film, and thus practical brazeability cannot be obtained unless the brazing conditions are suitable for the material.

In addition, breaking the oxide film caused by Mg relatively slowly proceeds under the influence of temperature and time. Therefore, in practical products comprising Mg, in the case where temperature differences are generated in the product during brazing, the breaking of the oxide film caused by Mg proceeds quickly in some areas and slowly in others, resulting in uneven fillet formation. Then, while a melted brazing substance flows into the joints where fillets have already formed by capillary force, the brazing substance flows out from the joints where fillets have not yet formed, and thus no fillets can be formed even when the oxide film is broken thereafter. Therefore, fatal unjointed parts are generated in practical products comprising numerous joint parts. Therefore, in order to obtain sufficient brazeability for the practical products comprising Mg, it is important to cause uniform and instant breaking of the oxide film caused by Mg to achieve brazing.

In order to break the oxide film uniformly and instantaneously, cladding the cladding material layer comprising no Mg or having very low Mg content onto the surface opposite to the core material of the brazing material layer after adding Mg to the brazing material layer is effective. In other words, although the oxide film on the material surface remains thin because the cladding material layer placed on the outermost surface does not comprise Mg before melting the brazing substance during brazing heating, Mg comprised in the brazing material layer can reach the surface of the cladding material layer all at once when the brazing material layer melts, and thus the oxide film is broken. However, even in the material provided with the cladding material layer as described above, the Mg concentration in the brazing material layer is low in the order of a few percent, and thus the action of reducing and breaking the oxide film is slow and sufficient brazeability cannot be obtained in the practical products. On the other hand, addition of a large amount of Mg into the brazing material causes cracks to be easily generated during material production and thus production of the brazing sheet to be difficult.

Therefore, the inventors of the present invention have conducted intensive study and have found that a method of using Bi is an effective method for increasing the Mg concentration that acts on the material surface during brazing without increasing the Mg content added to the brazing material layer.

Bi bonds to Mg to form an intermetallic compound formed of Mg₃Bi₂, and the Mg concentration in the Mg₃Bi₂ compound is extremely high as 85 mass %. Therefore, action of Mg₃Bi₂ on the oxide film allows the breaking action of the oxide film to be sharply enhanced and the brazeability reaches a practical level. However, Mg₃Bi₂ decomposes during brazing heating when the Mg and Bi concentrations are low, and thus the brazeability improvement effect described above is not sufficiently achieved. In addition, not only does the Mg concentration in the brazing material layer decrease but the Mg and Bi concentrations decrease by melting and mixing the brazing material layer and the cladding material layer and thus Mg₃Bi₂ decomposes in the melted brazing substance before acting on the oxide film. Therefore, as a result of the intensive study on the Mg and Bi concentrations providing excellent brazeability, the inventors of the present invention have found that the desired brazeability can be obtained by controlling the average values of the concentrations of Mg and Bi added to the brazing material layer and the cladding material layer in the thickness direction.

In other words, the average Mg concentration in the thickness direction of the internal brazing material 1 and the cladding material 1 is determined to be a concentration of more than 0.50 mass %, and the average Bi concentration in the thickness direction of the internal brazing material 1 and the cladding material 1 is determined to be a concentration of more than 0.050 mass %.

The average Mg concentration in the thickness direction of the internal brazing material 1 and the cladding material 1 is more than 0.50 mass %, more preferably 0.65 mass % or more, and further preferably 0.80 mass % or more. The average Mg concentration in the thickness direction of the internal brazing material 1 and the cladding material 1 within the above range allows the stability of Mg₃Bi₂ to be improved and an effect of delaying decomposition in the melted brazing substance to be sufficiently achieved. The average Mg concentration in the thickness direction of the internal brazing material 1 and the cladding material 1 is preferably higher concentrations from the viewpoint of brazeability, and thus the upper concentration limit may not be determined. This upper limit is determined by the upper limit of the Mg content of the internal brazing material 1, which is described separately.

The average Bi concentration in the thickness direction of the internal brazing material 1 and the cladding material 1 is more than 0.050 mass %, more preferably 0.065 mass % or more, and further preferably 0.080 mass % or more. The average Bi concentration in the thickness direction of the internal brazing material 1 and the cladding material 1 within the above range allows the stability of Mg₃Bi₂ to be improved and an effect of delaying decomposition in the melted brazing substance to be sufficiently achieved. The average Bi concentration in the thickness direction of the internal brazing material 1 and the cladding material 1 is preferably higher concentrations from the viewpoint of brazeability, and thus the upper concentration limit may not be determined. This upper limit is determined by the upper limit of the Bi content of the internal brazing material 1, which is described separately.

Here, in the present invention, the average Mg concentration in the thickness direction of the internal brazing material 1 and the cladding material 1 and the average Bi concentration in the thickness direction of the internal brazing material 1 and the cladding material 1 are determined as follows, when the Mg content of the internal brazing material 1 is defined as A₁ mass %, the Bi content of the internal brazing material 1 as B₁ mass %, the Mg content of the cladding material 1 as C₁ mass %, the Bi content of the cladding material 1 as Di mass %, the thickness of the internal brazing material 1 as T₁ (mm), and the thickness of the cladding material 1 as t₁ (mm).

$$Average Mg concentration ( \% ) in thickness direction of internal brazing material 1 and cladding material 1 = ( {A}_{1} \times {T}_{1} + {C}_{1} \times {t}_{1} ) / ( {T}_{1} + {t}_{1} )$$

$$Average Bi concentration ( \% ) in thickness direction of internal brazing material 1 and cladding material 1 = ( {B}_{1} \times {T}_{1} + {D}_{1} \times {t}_{1} ) / ( {T}_{1} + {t}_{1} )$$

The thickness of the internal brazing material 1 is preferably 15.0 μm or more. As the internal brazing material 1 becomes thicker, the absolute amount of the Mg₃Bi₂ compound becomes larger, resulting in promoting the breaking of the oxide film. A thickness of the internal brazing material 1 of 15.0 μm or more allows the average Mg concentration in the thickness direction of the internal brazing material 1 and the cladding material 1 and the average Bi concentration in the thickness direction of the internal brazing material 1 and the cladding material 1 to be easily adjusted to a predetermined concentration. The upper limit of the thickness of the internal brazing material 1 may be defined, and the range of the thickness of the internal brazing material 1 required for the practical products is about 15.0 μm to about 400 μm.

The thickness of the cladding material 1 is preferably 5.0 μm or more. As the cladding material 1 becomes thicker, the brazeability is more improved because Mg in the internal brazing material 1 is difficult to diffuse to the surface of the cladding material 1. A thickness of the cladding material 1 of 5.0 μm or more allows oxidation prevention action of Mg to be easily achieved due to difficultly in diffusion of Mg in the internal brazing material 1 to the surface of the cladding material 1. The upper limit of the thickness of the cladding material 1 may not be defined, and the thickness of the cladding material 1 is preferably 120 μm or less from the viewpoint that the average Mg concentration in the thickness direction of the internal brazing material 1 and the cladding material 1 and the average Bi concentration in the thickness direction of the internal brazing material 1 and the cladding material 1 are easily adjusted. Therefore, a practical range of the thickness of the cladding material 1 is about 5.0 μm to about 120 μm.

1.5 In the case where the aluminum alloy brazing sheet of the first embodiment of the present invention or the aluminum alloy brazing sheet of the second embodiment of the present invention comprises the internal brazing material 2 and the cladding material 2, the average Mg concentration in the thickness direction of the internal brazing material 2 and the cladding material 2 is preferably determined to be a concentration of more than 0.50 mass % and the average Bi concentration in the thickness direction of the internal brazing material 2 and the cladding material 2 is preferably determined to be a concentration of more than 0.050 mass %.

The sacrificial anode material A according to the aluminum alloy brazing sheet of the first embodiment of the present invention, the sacrificial anode material B1 according to the aluminum alloy brazing sheet of the second embodiment of the present invention, and the sacrificial anode material B2 according to the aluminum alloy brazing sheet of the second embodiment of the present invention are formed of an aluminum alloy comprising any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and formed with the balance being Al and inevitable impurities. The sacrificial anode material A, the sacrificial anode material B1, and the sacrificial anode material B2 are hereinafter collectively referred to as simply the “sacrificial anode material”.

In the sacrificial anode material formed of the aluminum alloy, Si contributes to strength enhancement. In the case where the sacrificial anode material comprises Si, the Si content in the sacrificial anode material is 5.00 mass % or less, preferably 0.10 mass % to 1.50 mass %, and particularly preferably 0.10 mass % to 1.00 mass %. The Si content in the sacrificial anode material in the above range allows the strength of the sacrificial anode material to be improved. The Si content in the sacrificial anode material is 1.50 mass % to 5.00 mass % and particularly preferably 2.50 mass % to 4.50 mass %. In the range of the content of 1.50 mass % to 5.00 mass %, the material is in a semi-melted state during brazing heating and thus brazeability is improved in the case where the sacrificial anode material surface acts as a brazed surface by supplying a small amount of liquid phase brazing substance. On the other hand, a Si content in the sacrificial anode material of more than the above range causes the melting point to be excessively low, local melting to occur during brazing, and deformation of the sacrificial anode material to occur.

Fe contributes to strength enhancement. In the case where the sacrificial anode material comprises Fe, the Fe content in the sacrificial anode material is 1.50 mass % or less and preferably 0.10 mass % to 0.70 mass %. The Fe content in the sacrificial anode material within the above range allows the strength of the sacrificial anode material to be improved. On the other hand, a Fe content in the sacrificial anode material of more than the range causes corrosion resistance to deteriorate and giant compounds to be easily generated.

Cu contributes to strength enhancement and potential adjustment. In the case where the sacrificial anode material comprises Cu, the Cu content in the sacrificial anode material is 2.00 mass % or less and preferably 0.10 mass % to 1.00 mass %. The Cu content in the sacrificial anode material within the above range allows the strength of the sacrificial anode material to be improved. On the other hand, a Cu content in the sacrificial anode material of more than the above range causes intergranular corrosion to easily occur and the melting point to be excessively low.

Mn contributes to strength enhancement and potential adjustment. In the case where the sacrificial anode material comprises Mn, the Mn content in the sacrificial anode material is 2.00 mass % or less and preferably 0.30 mass % to 1.80 mass %. The Mn content in the sacrificial anode material within the above range allows the strength of the sacrificial anode material to be improved and the effect of adjusting the potential to be achieved. On the other hand, a Mn content in the sacrificial anode material of more than the above range causes cracks to be easily generated during material rolling.

Mg contributes to strength enhancement. In the case where the sacrificial anode material comprises Mg, the Mg content in the sacrificial anode material is 3.00 mass % or less and preferably 0.30 mass % to 1.80 mass %. The Mg content in the sacrificial anode material within the above range allows the effect of the strength enhancement to be easily achieved. On the other hand, a Mg content in the sacrificial anode material of more than the above range causes cracks to be easily generated during material rolling.

Zn contributes to potential adjustment. In the case where the sacrificial anode material comprises Zn, the Zn content in the sacrificial anode material is 6.00 mass % or less and preferably 3.00 mass % or less. The Zn content in the sacrificial anode material within the above allo the sacrificial protection effect to be improved. On the other hand, a Zn content in the sacrificial anode material of more than the above range causes the potential of the sacrificial anode material to be excessively lowered and thus corrosion may rapidly progress.

Cr improves strength by solid solution strengthening, also precipitates fine Al—Cr-based compounds, and acts on coarsening grains after brazing. The Cr content in the sacrificial anode material is 0.30 mass % or less and preferably 0.10 mass % to 0.20 mass %. The Cr content in the sacrificial anode material in the above range allows the strength of the sacrificial anode material to be improved. On the other hand, a Cr content in the sacrificial anode material of more than the above range causes giant intermetallic compounds to be easily formed during casting and thus plastic workability to deteriorate.

Ti improves strength by solid solution strengthening, and is distributed in layers to form high and low potential layers in the sacrificial anode material, whereby the corrosion form changes from pitting corrosion to layer corrosion to exhibit the effect of improving corrosion resistance. The Ti content in the sacrificial anode material is 0.30 mass % or less and preferably 0.10 mass % to 0.20 mass %. The Ti content in the sacrificial anode material within the above range allows the strength of the sacrificial anode material to be improved and corrosion resistance to be improved. On the other hand, a Ti content in the sacrificial anode material of more than the above range causes giant intermetallic compounds to be easily formed during casting and thus plastic workability to deteriorate.

Zr improves strength by solid solution strengthening, also precipitates Al—Zr-based fine compounds, and acts on coarsening grains after brazing. The Zr content in the sacrificial anode material is 0.30 mass % or less and preferably 0.10 mass % to 0.20 mass %. The Zr content in the sacrificial anode material within the above range allows the strength of the sacrificial anode material to be improved and the effect of coarsening grains after brazing to be achieved. On the other hand, a Zr content in the sacrificial anode material of more than the above range causes giant intermetallic compounds to be easily formed during casting and thus plastic workability to deteriorate.

The sacrificial anode material may comprise 0.050 mass % or less of Ag, B, Be, Bi, Ca, Cd, Co, Ga, Ge, Hg, In, Li, Mo, Na, Ni, P, Pb, Sb, Sn, Sr, V, and Y as unavoidable impurities.

The outer surface brazing material according to the aluminum alloy brazing sheet of the first embodiment of the present invention and the outer surface brazing material according to the aluminum alloy brazing sheet of the second embodiment of the present invention are formed of an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

The outer surface brazing material comprises Si. In the outer surface brazing material formed of the aluminum alloy, Si contributes to brazing jointability. The Si content in the outer surface brazing material is 6.00 mass % to 13.00 mass %. The Si content in the outer surface brazing material within the above range allows sufficient brazing jointability to be obtained. A Si content in the outer surface brazing material of less than the above range causes jointability to be inferior, whereas a Si content of more than the above range causes cracks to be easily generated during material production and thus the production of the brazing sheet to be difficult.

In the case where the outer surface brazing material comprises Fe, the Fe content in the outer surface brazing material is 1.00 mass % or less and preferably 0.10 mass % to 0.50 mass %. The Fe content in the outer surface brazing material within the above range allows the effect of forming fine grains to be easily achieved. On the other hand, a Fe contents in the outer surface brazing material of more than the above range causes giant intermetallic compounds to be easily formed during casting and thus plastic workability to deteriorate.

In the case where the outer surface brazing material comprises Cu, the Cu content in the outer surface brazing material is 2.00 mass % or less and 0.50 mass % to 2.00 mass %. The Cu content in the outer surface brazing material within the above range allows the effect of lowering the melting point of the brazing material to be improved. On the other hand, a Cu content in the outer surface brazing material of more than the above range causes cracks to be generated during material production and thus production of the brazing sheet to be difficult.

In the case where the outer surface brazing material comprises Mn, the Mn content in the outer surface brazing material is 2.00 mass % or less and preferably 0.10 mass % to 0.60 mass %. The Mn content in the outer surface brazing material within the above range allows the effect of coarsening grains to be easily achieved. On the other hand, a Mn contents in the outer surface brazing material of more than the above range causes giant intermetallic compounds to be easily formed during casting and thus plastic workability to be easily decreased.

In the case where the outer surface brazing material comprises Mg, the Mg content in the outer surface brazing material is 4.50 mass % or less and preferably 0.60 mass % to 4.00 mass %. The Mg content in the outer surface brazing material within the above range allows sufficient brazing jointability to be obtained. A Mg content in the outer surface brazing material of equal to or less than the above range causes the effect of breaking the oxide film to be insufficient, whereas a Mg content of more than the above range causes cracks to be easily generated during material production and thus production of the brazing sheet to be difficult.

In the case where the outer surface brazing material comprises Zn, the Zn content in the outer surface brazing material is preferably 6.00 mass % or less from the viewpoint of easily achieving the effect of lowering the melting point of the brazing material. On the other hand, a Zn content in the outer surface brazing material of more than 6.00 mass % causes cracks to be generated during material production and thus production of the brazing sheet to be difficult. In addition, in the case where the outer surface brazing material comprises Zn, the Zn content in the outer surface brazing material is 3.00 mass % or less from the viewpoint that the effect of preventing corrosion of the core material is easily achieved by setting the potential of the brazing material less-noble and preferentially corroding the outer surface brazing material against the core material.

In the case where the outer surface brazing material comprises Bi, the Bi content in the outer surface brazing material is 0.50 mass % or less. The Bi content in the outer surface brazing material within the above range allows the sufficient brazing jointability to be obtained. A Bi content in the outer surface brazing material of less than the above range causes the action of promoting the breaking effect of the oxide film caused by Mg to be insufficient, whereas a Bi content of more than the above range causes cracks to be easily generated during material production and thus the production of the brazing sheet to be difficult.

In the case where the outer surface brazing material comprises Cr, the Cr content in the outer surface brazing material is 0.30 mass % or less and preferably 0.10 mass % to 0.20 mass %. The Cr content in the outer surface brazing material within the above range allows the effect of coarsening grains to be easily achieved. On the other hand, a Cr content in the outer surface brazing material of more than the above range causes giant intermetallic compounds to be easily formed during casting, and plastic workability to deteriorate.

In the case where the outer surface brazing material comprises Ti, The Ti content in the outer surface brazing material is 0.30 mass % or less and preferably 0.10 mass % to 0.20 mass %. The Ti content in the outer surface brazing material within the above range allows the effect of coarsening grains to be easily achieved. On the other hand, a Ti content in the outer surface brazing material of more than the above range causes giant intermetallic compounds to be easily formed during casting and thus plastic workability to deteriorate.

In the case where the outer surface brazing material comprises Zr, the Zr content in the outer surface brazing material is 0.30 mass % or less and preferably 0.10 mass % to 0.20 mass %. The Zr content in the outer surface brazing material within the above range allows the effect of coarsening grains to be easily achieved. On the other hand, a Zr content in the outer surface brazing material of more than the above range causes giant intermetallic compounds to be easily formed during casting and thus plastic workability to deteriorate.

The grain size after brazing is adjusted by utilizing the above actions. The effects of the present invention can be sufficiently achieved when the contents are within the above ranges.

The outer surface brazing material may comprise any one or more of Na, Sr, and Sb. In the aluminum alloy forming the outer surface brazing material, Na, Sr, and Sb exhibit the effect of forming fine Si particles in the brazing material and improving the flowability of the brazing substance. In the case where the outer surface brazing material comprises Na, the Na content in the outer surface brazing material is 0.050 mass % or less and preferably 0,005 mass % to 0.040 mass %. In the case where the outer surface brazing material comprises Sr, the Sr content in the outer surface brazing material is 0.050 mass % or less and preferably 0.005 mass % to 0.040 mass %. In the case where the outer surface brazing material comprises Sb, the Sb content in the outer surface brazing material is 0.050 mass % or less and preferably 0.005 mass % to 0,040 mass %. The Na, Sr, and Sb contents in the outer surface brazing material within the above ranges allow the effect of forming fine Si particles to be achieved. On the other hand, contents of Na, Sr, and Sb in the outer surface brazing material of more than the above ranges cause the effect to be saturated, which is not economical.

The outer surface brazing material may comprise 0.050 mass % or less of Ag, B, Be, Ca, Cd, Co, Ga, Ge, Hg, In, Li, Mo, Ni, P, Pb, Sn, V, and Y as unavoidable impurities.

As a method for producing the aluminum alloy brazing sheet of the first embodiment of the present invention and the aluminum alloy brazing sheet of the second embodiment of the present invention, the following production method can be exemplified. First, aluminum alloy ingots having the compositions of the core material according to the aluminum alloy brazing sheet of first embodiment of the present invention and the aluminum alloy brazing sheet of the second embodiment of the present invention are prepared, and the aluminum alloy ingots for the core material are set to a predetermined thickness. In addition, aluminum alloy ingots having the compositions of aluminum alloy ingots for the clad (cladding material 1, cladding material 2, internal brazing material 1, internal brazing material 2, sacrificial anode material A, sacrificial anode material B1, sacrificial anode material B2, and outer surface brazing material) according to the aluminum alloy brazing sheet of first embodiment of the present invention and the aluminum alloy brazing sheet of second embodiment of the present invention are prepared and these aluminum alloy ingots are processed into predetermined thicknesses by hot rolling or other methods. Subsequently, the aluminum alloy ingot for the core material is subjected to homogenization treatment at 450° C. to 630° C. for 1 hour to 100 hours, if necessary. Subsequently, the aluminum alloy ingot for the core material and the predetermined aluminum alloy ingots for the clad are stacked in a predetermined stacking order and the stacked ingots are subjected to hot rolling at 400° C. to 550° C. Subsequently, the hot-rolled product is subjected to one or more passes of cold rolling and, if necessary, intermediate annealing and/or final annealing at 250° C. to 450° C. for 1 hour to 24 hours to a predetermined thickness to give the aluminum alloy brazing sheet of the first embodiment of the present invention or the aluminum alloy brazing sheet of the second embodiment of the present invention.

The aluminum alloy brazing sheet of the first embodiment of the present invention and the aluminum alloy brazing sheet of the second embodiment of the present invention are processed into predetermined shapes of heat exchanger components. The processed products are combined together with other heat exchanger components as part of the heat exchanger and subsequently the combined product is subjected to brazing heating in an inert gas atmosphere at the maximum temperature of 580° C. to 630° C. for 1 minute to 10 minutes without using a flux to perform brazing, resulting in completing the heat exchanger:

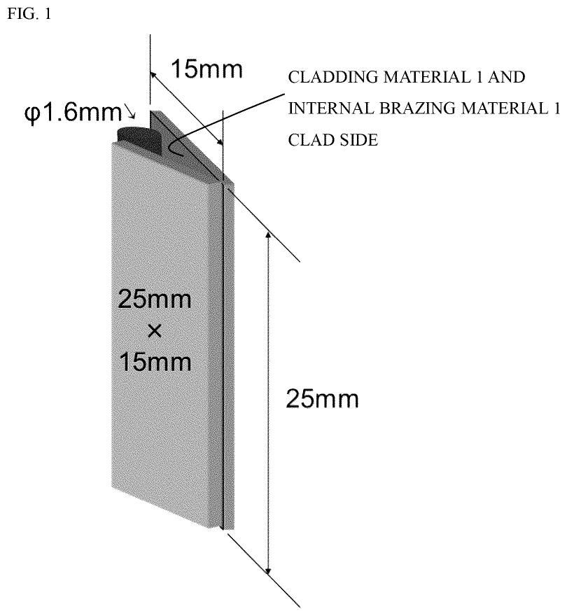

The aluminum alloy brazing sheet of the first embodiment of the present invention and the aluminum alloy brazing sheet of the second embodiment of the present invention have excellent brazeability in brazing in the inert gas atmosphere. The brazeability of clad sheet materials is generally evaluated by a clearance filling test (LWS T 8801). This clearance filling test, however, is insufficient to evaluate the practical brazeability so that the brazing substance is flowed in and flowed out among a plurality of joint parts, because the fillet is formed from one point and grows. In order to solve this problem, therefore, the inventors of the present invention have developed an “overlapped opening-mouth test” and have evaluated the brazeability of each test material. As illustrated in FIG. 1, the overlapped opening-mouth test described below is a test in which a test material cut into a predetermined size of, for example, 15 mm in width and 25 mm in length and a bare material of A3003-O having a thickness of 1.0 mm cut into a predetermined size of, for example, 15 mm in width and 25 mm in length are overlapped so that the surface of the side where the cladding material 1 and the internal brazing material 1 are cladded is arranged inside, a spacer having a diameter of 1.6 mm is inserted into the bare material by lifting one side of the bare material, and the test material and the bare material on the opposite side to the spacer are brought into linearly contact, whereby a test body provided with a very small clearance between the test material and the bare material is prepared and the test body is brazed in a state where the linear contact part of the test material and the bare material is in parallel with gravity. In the brazing heating in the overlapped opening-mouth test, the test material is assembled to the overlapped opening-mouth test body and thereafter is subjected to brazing heating in a furnace in a nitrogen gas atmosphere without using a flux. In the brazing heating conditions, an oxygen concentration in the furnace is controlled at 50 ppm or less and a dew point of −45° C. or less when the temperature of the test body during the temperature rise is 400° C. or more, and the oxygen concentration is controlled at 10 ppm or less and the dew point of −60° C. or less when the temperature of the test body is 570° C. or more. The maximum temperature of the test body is determined to be 600° C., In this overlapped opening-mouth test, for example, in the case where the oxide film breaking is delayed on the upper side compared to the lower side in the gravity direction, the fillet is formed first on the lower side, and thus the brazing material that is expected to form the fillet on the upper side may flow out to the lower side where the fillet is formed. This test is an extremely excellent evaluation method that can easily evaluate the inflow and outflow of the brazing substance in practical products. Therefore, according to the overlapped opening-mouth test, the practical brazeability in which inflow and outflow of the brazing substance between the joint parts occur can be adequately evaluated.

Hereinafter, the present invention will be specifically described with reference to Examples. The present invention, however, is not limited to Examples described below.

### EXAMPLES

### Examples and Comparative Examples

Each of an ingot for a core material, an ingot for an internal brazing material, and an ingot for a cladding material having compositions listed in Table 1 was formed by continuous casting. With respect to the ingot for the core material, the obtained ingot was machined to a size of 163 mm in length, 163 mm in width, and 27 mm in thickness. With respect to the ingot for the cladding material and the ingot for the brazing material, the obtained ingots were hot rolled at 500° C. to a thickness of 3 mm, cold rolled to a predetermined thickness, and cut into a dimension of 163 mm in length and 163 mm in width.

TABLE 1

| Alloy No. | | Si | Fe | Cu | Mn | Mg | Zn | Ti | Bi |
|---|---|---|---|---|---|---|---|---|---|
| A3003 | Core material | 0.28 | 0.61 | 0.16 | 1.20 | 0.01 | 0.02 | 0.01 | <0.01 |
| C01 | Cladding material | 7.30 | 0.19 | <0.01 | <0.01 | <0.01 | <0.01 | <0.01 | <0.01 |
| F01 | Internal brazing material | 7.50 | 0.19 | <0.01 | <0.01 | 0.33 | <0.01 | <0.01 | 0.15 |
| F02 | Internal brazing material | 7.50 | 0.19 | <0.01 | <0.01 | 1.10 | <0.01 | <0.01 | 0.14 |
| F03 | Internal brazing material | 7.50 | 0.19 | <0.01 | <0.01 | 1.00 | <0.01 | <0.01 | 0.31 |
| F04 | Internal brazing material | 7.70 | 0.20 | <0.01 | <0.01 | 2.00 | <0.01 | <0.01 | 0.13 |
| F05 | Internal brazing material | 7.90 | 0.20 | <0.01 | <0.01 | 2.40 | <0.01 | <0.01 | <0.01 |
| F06 | Internal brazing material | 7.80 | 0.20 | <0.01 | <0.01 | 2.50 | <0.01 | <0.01 | 0.12 |
| F07 | Internal brazing material | 7.50 | 0.19 | <0.01 | <0.01 | 2.50 | <0.01 | <0.01 | 0.25 |
| F08 | Internal brazing material | 8.00 | 0.19 | <0.01 | <0.01 | 4.20 | <0.01 | <0.01 | 0.08 |

The prepared ingot for the core material, ingot for the internal brazing material, and ingot for the cladding material were hot rolled and cold rolled in the combinations listed in Table 2 to set the thickness to 0.6 mm. Thereafter, final annealing was performed at 360° C. using a common method to give an annealed clad sheet material stacked in order of cladding material 1/internal brazing material 1/core material (in Comparative Example 1, in order of internal brazing material 1/core material). The obtained clad sheet material was used as the test material.

TABLE 2

| | | | | | | Average concentration of | |
|---|---|---|---|---|---|---|---|
| | | | | | | internal brazing material | |
| | Alloy No. | | | Clad ratio (%) | | and cladding material | |
| | | Internal | | | Internal | Average Mg | Average Bi |
| | Cladding | brazing | Core | Cladding | brazing | concentration | concentration |
| | material | material | material | material | material | (%) | (%) |
| Example 1 | C01 | F02 | A3003 | 1.25 | 8.75 | 0.88 | 0.13 |
| Example 2 | C01 | F04 | A3003 | 5.00 | 5.00 | 1.00 | 0.08 |
| Example 3 | C01 | F08 | A3003 | 5.00 | 5.00 | 2.00 | 0.08 |
| Example 4 | C01 | F07 | A3003 | 1.25 | 8.75 | 2.19 | 0.26 |
| Example 5 | C01 | F03 | A3003 | 1.25 | 8.75 | 0.88 | 0.26 |
| Example 6 | C01 | F06 | A3003 | 1.25 | 8.75 | 2.19 | 0.13 |
| Comparative | — | F03 | A3003 | — | 10.00 | 1.00 | 0.30 |
| Example 1 | | | | | | | |
| Comparative | C01 | F01 | A3003 | 2.50 | 7.50 | 0.23 | 0.11 |
| Example 2 | | | | | | | |
| Comparative | C01 | F05 | A3003 | 1.25 | 8.75 | 2.19 | 0.00 |
| Example 3 | | | | | | | |

Subsequently, the obtained clad sheet materials were subjected to an overlapped opening-mouth test described below. The results are listed in Table 3.

### <Overlapped Opening-Mouth Test

As illustrated in FIG. 1, a test material cut into 15 mm in width and 25 mm in length and a bare material of A3003-O having a thickness of 1.0 mm cut into 15 mm in width and 25 mm in length were overlapped so that the surface of the side where the cladding material 1 and the internal brazing material 1 were cladded was arranged inside, a spacer having a diameter of 1.6 mm was inserted into the bare material by lifting one side of the bare material, and the test material and the bare material on the opposite side to the spacer was brought into linearly contact, whereby a test body provided with a very small clearance between the test material and the bare material was prepared.

Subsequently, the test material was assembled into the overlapped opening-mouth test body, the test body was subjected to brazing heating in a furnace in a nitrogen atmosphere without using a flux, in a state where the linear contact part of the test material and the bare material was in parallel with gravity. In the brazing heating conditions, an oxygen concentration in the furnace was controlled at 50 ppm or less and a dew point of −45° C. or less when the temperature of the test body was 400° C. or more during the temperature rise, and the oxygen concentration was controlled at 10 ppm or less and the dew point of −60° C. or less when the temperature of the test body was 570° C. or more. The maximum temperature of the test body was determined to be 600° C.

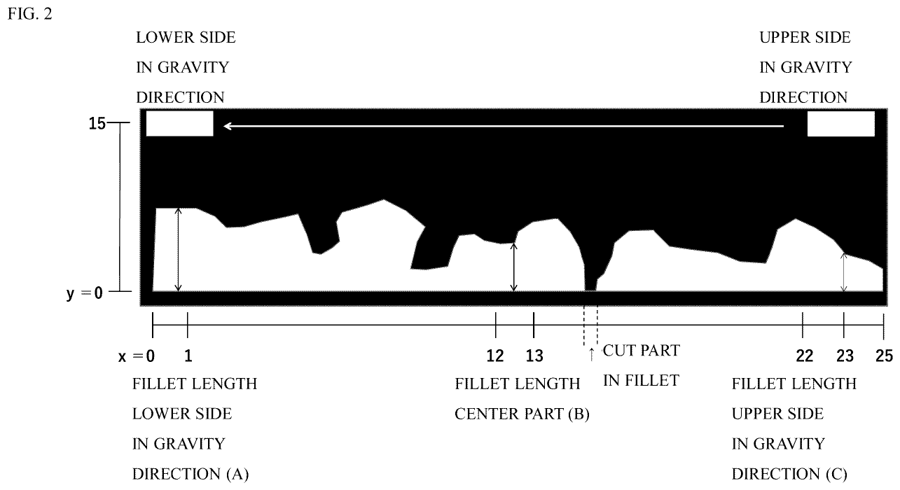

After the brazing heating, a fillet shape formed in the very small clearance of the overlapped opening-mouth test body was photographed by X-ray CT. The photographing conditions were set to a tube voltage of 160 kV and a tube current of 100 μA, and the entire test body was photographed. FIG. 2 illustrates a schematic view of the acquired X-ray CT image. The fillet is illustrated in white. The left side of FIG. 2 is the lower side of the gravity and the right side is the upper side of the gravity. The obtained X-ray CT image was analyzed by ImageJ. The X-ray CT image was binarized in black and white. The direction of gravity was determined to be the x-axis and the fillet length perpendicular to the x-axis was quantified. From the results of the analysis, circle and cross determination was performed for each of the following three indicators.
(Indicator 1) In a range where both edges in which no fillets existed were eliminated, the case where the fillet length equaled to zero, that is, no fillets existed was determined to be “cut part existing in the fillet” (x), whereas the case where the fillet length did not equal to zero was determined to be “no cut part existing in the fillet” (∘).
(Indicator 2) When the lower edge part of the fillet in the gravity direction was determent to be x=0, the minimum fillet length of x=12 mm to 13 mm was determine to be a center part (B), the minimum fillet length of x=22 mm to 23 mm was determined to be an upper side in the gravity direction (C), and the maximum fillet length of x=0 mm to 1 mm was determined to be a lower side in the gravity direction (A), “((B+C)/2)/A” was determined to be a gravity effected coefficient of the fillet length. A larger coefficient means that more uniform fillet was formed by defying gravity. The case where the coefficient was 0.35 or more was determined to be (∘), whereas the coefficient was less than 0.34 was determined to be (x)

TABLE 3

| | |
|---|---|
| Indicator 1 | Indicator 2 |

| | | | |
|---|---|---|---|
| Example 1 | ∘ | 0.45 | ∘ |
| Example 2 | ∘ | 0.46 | ∘ |
| Example 3 | ∘ | 0.37 | ∘ |
| Example 4 | ∘ | 0.48 | ∘ |
| Example 5 | ∘ | 0.45 | ∘ |
| Example 6 | ∘ | 0.97 | ∘ |
| Comparative | ∘ | 0.25 | x |
| Example 1 | | | |
| Comparative | x | 0.56 | ∘ |
| Example 2 | | | |
| Comparative | x | 0.33 | x |
| Example 3 | | | |

From the above results, it is found that the aluminum alloy brazing sheet of the first embodiment of the present invention comprises the internal brazing material 1 and the cladding material 1 in which the chemical compositions are within the defined range of the present invention and the average Mg concentration and the average Bi concentration in the thickness direction of these materials are within the defined range of the present invention, whereby has excellent brazeability in brazing in an inert gas atmosphere without using a flux.

In addition, from the above results, it is found that the aluminum alloy brazing sheet comprising the cladding material 1 serving as the outermost layer in which the chemical composition is within the defined range of the present invention, comprising the internal brazing material in which the chemical composition is within the defined range of the present invention placed just under the cladding material 1, and setting the average Mg concentration and the average Bi concentration in the thickness direction of these materials within the defined range of the present invention, whereby has excellent brazeability in brazing in an inert gas atmosphere without using a flux. Therefore, it is similarly assumed that the aluminum alloy brazing sheet of the second embodiment of the present invention comprising the cladding material 1 serving as the outermost layer in which the chemical composition is within the defined range of the present invention, comprising the internal brazing material in which the chemical composition is within the defined range of the present invention placed just under the cladding material 1, and setting the average Mg concentration and the average Bi concentration in the thickness direction of these materials within the defined range of the present invention, whereby also has excellent brazeability in brazing in an inert gas atmosphere without using a flux.

1. An aluminum alloy brazing sheet comprising:
a core material formed of pure aluminum or an aluminum alloy; and
an internal brazing material 1 and a cladding material 1 cladded on at least one side surface of the core material in order of cladding material 1/internal brazing material 1/core material,
the aluminum alloy brazing sheet being used for brazing in an inert gas atmosphere without using a flux, wherein
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities,
the cladding material 1 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities, and
an average Mg concentration in a thickness direction of the internal brazing material 1 and the cladding material 1 is more than 0.50 mass % and an average Bi concentration in the thickness direction of the internal brazing material 1 and the cladding material 1 is more than 0.050 mass %.

2. The aluminum alloy brazing sheet according to claim 1, further comprising
a sacrificial anode material A cladded on another side surface of the core material in order of cladding material 1/internal brazing material 1/core material/sacrificial anode material A, wherein
the sacrificial anode material A is formed of an aluminum alloy comprising any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and formed with the balance being Al and inevitable impurities.

3. The aluminum alloy brazing sheet according to claim 1, further comprising
an outer surface brazing material cladded on another side surface of the core material in order of cladding material 1/internal brazing material 1/core material/outer surface brazing material, wherein
the outer surface brazing material is formed of an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

4. The aluminum alloy brazing sheet according to claim 2, further comprising
an outer surface brazing material cladded on a surface of the sacrificial anode material A on an opposite side to the core material in order of cladding material 1/internal brazing material 1/core material/sacrificial anode material A/outer surface brazing material, wherein
the outer surface brazing material is formed of an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

5. The aluminum alloy brazing sheet according to claim 2, further comprising
an internal brazing material 2 and a cladding material 2 cladded on a surface of the sacrificial anode material A on an opposite side to the core material in order of cladding material 1/internal brazing material 1/core material/sacrificial anode material A/internal brazing material 2/cladding material 2, wherein
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

6. The aluminum alloy brazing sheet according to claim 1, further comprising
an internal brazing material 2 and a cladding material 2 cladded on another side surface of the core material in order of cladding material 1/internal brazing material 1/core material/internal brazing material 2/cladding material 2, wherein
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

7. An aluminum alloy brazing sheet comprising:
a core material formed of pure aluminum or an aluminum alloy; and
a sacrificial anode material B1, an internal brazing material 1, and a cladding material 1 cladded on at least one side surface of the core material in order of cladding material 1/internal brazing material 1/sacrificial anode material B1/core material,
the aluminum alloy brazing sheet being used for brazing in an inert gas atmosphere without using a flux, wherein
the internal brazing material 1 is formed of an aluminum alloy comprising 6.00 mass % to 13.00 mass % of Si, more than 0.50 mass % and 4.50 mass % or less of Mg, and 0.010 mass % to 0.50 mass % of Bi and formed with the balance being Al and inevitable impurities,
the cladding material 1 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities,
the sacrificial anode material B1 comprises any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and is formed with the balance being Al and inevitable impurities, and
an average Mg concentration in a thickness direction of the internal brazing material 1 and the cladding material 1 is more than 0.50 mass % and an average Bi concentration in the thickness direction of the internal brazing material 1 and the cladding material 1 is more than 0.050 mass %.

8. The aluminum alloy brazing sheet according to claim 7, further comprising
a sacrificial anode material B2 cladded on another side surface of the core material in order of cladding material 1/internal brazing material 1/sacrificial anode material B1/core material/sacrificial anode material B2, wherein
the sacrificial anode material B2 is an aluminum alloy comprising any one or more of 5.00 mass % or less of Si, 1.50 mass % or less of Fe, 2.00 mass % or less of Cu, 2.00 mass % or less of Mn, 3.00 mass % or less of Mg, 6.00 mass % or less of Zn, 0.30 mass % or less of Cr, 0.30 mass % or less of Ti, and 0.30 mass % or less of Zr, and formed with the balance being Al and inevitable impurities.

9. The aluminum alloy brazing sheet according to claim 7, further comprising
an outer surface brazing material cladded on another side surface of the core material in order of cladding material 1/internal brazing material 1/sacrificial anode material B1/core material/outer surface brazing material, wherein
the outer surface brazing material is an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

10. The aluminum alloy brazing sheet according to claim 8, further comprising
an outer surface brazing material cladded on a surface of the sacrificial anode material B2 on an opposite side to the core material in order of cladding material 1/internal brazing material 1/sacrificial anode material B1/core material/sacrificial anode material B2/outer surface brazing material, wherein
the outer surface brazing material is an aluminum alloy comprising 6.00 mass % to 13.00 mass % of Si, further comprising any one or more of 1.00 mass % or less of Fe, 2.00 mass % or less of Cu, 2.00 mass % or less of Mn, 4.50 mass % or less of Mg, 6.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

11. The aluminum alloy brazing sheet according to claim 8, further comprising
an internal brazing material 2 and a cladding material 2 cladded on a surface of the sacrificial anode material B2 on an opposite side to the core material in order of cladding material 1/internal brazing material 1/sacrificial anode material B1/core material/sacrificial anode material B2/internal brazing material 2/cladding material 2, wherein
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

12. The aluminum alloy brazing sheet according to claim 7, further comprising
an internal brazing material 2 and a cladding material 2 cladded on another side surface of the core material in order of cladding material 1/internal brazing material 1/sacrificial anode material B1/core material/internal brazing material 2/cladding material 2, wherein
the internal brazing material 2 is formed of an aluminum alloy comprising 6.00 mass % to 13.00 mass % of Si, more than 0.50 mass % and 4.50 mass % or less of Mg, and 0.010 mass % to 0.50 mass % of Bi, and formed with the balance being Al and inevitable impurities, and
the cladding material 2 is formed of an aluminum alloy comprising 6.00 mass % to 13.00 mass % of Si, having a Mg content of 0.050 mass % or less, having a Bi content of 0.050 mass % or less, and formed with the balance being Al and inevitable impurities.

13. The aluminum alloy brazing sheet according to claim 1, wherein the core material is formed of an aluminum alloy comprising any one or more of 1.50 mass % or less of Si, 1.50 mass % or less of Fe, 2.00 mass % or less of Cu, 2.00 mass % or less of Mn, 3.00 mass % or less of Mg, 3.00 mass % or less of Zn, 0.50 mass % or less of Bi, 0.30 mass % or less of Cr, 0.30 mass % or less of Ti, and 0.30 mass % or less of Zr, and formed with the balance being Al and inevitable impurities.

14. The aluminum alloy brazing sheet according to claim 1, wherein the internal brazing material 1 or the internal brazing material 2 further comprises any one or more of 1.00 mass % or less of Fe, 2.00 mass % or less of Cu, 2.00 mass % or less of Mn, 6.00 mass % or less of Zn, 0.30 mass % or less of Cr, 0.30 mass % or less of Ti, and 0.30 mass % or less of Zr.

15. The aluminum alloy brazing sheet according to claim 1, wherein the cladding material 1 or the cladding material 2 further comprises any one or more of 1.00 mass % or less of Fe, 2.00 mass % or less of Cu, 2.00 mass % or less of Mn, 6.00 mass % or less of Zn, 0.30 mass % or less of Cr, 0.30 mass % or less of Ti, and 0.30 mass % or less of Zr.

16. The aluminum alloy brazing sheet according to claim 1, wherein a thickness of the cladding material 1 or the cladding material 2 is 5.0 μm or more.

17. The aluminum alloy brazing sheet according to claim 1, wherein a thickness of the internal brazing material 1 or the internal brazing material 2 is 15.0 μm or more.
